(19) United States
(12) Patent Application Publication
(10) Pub. No.: US 2016/0033787 A1
(43) Pub. Date: Feb. 4, 2016

(54) LEASH APPARATUS FOR USE IN RETAINING AN EYEGLASS ON A USERS BODY

(71) Applicant: Gene Kaialii Relampagos, Eugene, OR (US)

(72) Inventor: Gene Kaialii Relampagos, Eugene, OR (US)

(21) Appl. No.: 14/812,966

(22) Filed: Jul. 29, 2015

Related U.S. Application Data
(60) Provisional application No. 62/031,611, filed on Jul. 31, 2014.

(51) Int. Cl. G02C 3/00

(52) U.S. Cl. CPC G02C 3/003; G02C 2200/24

(57) ABSTRACT

A leash apparatus for use with an eyeglass retaining band to maintain an eyeglass at a desired position on a user's body is provided. The leash apparatus includes a resilient tether having a first end and a second end, the tether able to extend or compress to a desired length, a first ring mechanically coupled to the first end of the tether and able to be secured around the eyeglass retaining band, and a clip mechanically coupled to the second end of the tether and having a pair of jaws, the clip having an adjustment mechanism to adjust a separation distance between the jaws to be sufficiently large to receive an article on the body of the user. The tether adjusts to the desired length to permit the jaws to secure the article therein.

### RELATED APPLICATION

The application claims priority to provisional patent application U.S. Ser. No. 62/031,611 filed on Jul. 31, 2014, the entire contents of which is herein incorporated by reference.

### BACKGROUND

The embodiments herein relate generally to eyeglass retainers and other devices designed to maintain eyeglasses in a desired position on a user's body.

The majority of individuals wear eyeglasses, which may include prescription eyewear, sunglasses, protective eyewear, or the like. These eyeglasses comprise a frame to secure lenses above the eyes and a pair of temples that extend along the sides of the user's head and around the ears. This configuration is designed to keep the eyeglass on the user's head. However, if the user sweats or engages in an athletic or cardiovascular type activity, the eyeglass often slips on the user's face or completely falls off the head.

There exist a variety of eyeglass retainers that comprise a band with ends that are secured to the temple tips of the eyeglass. The band is placed around the user's head or neck region to maintain the eyeglass in a desired position around the head or neck. Typically, the eyeglass retainer includes an adjustment mechanism to tighten or loosen the band to comfortably fit around the user's head region. However, these eyeglass retainers are limited because they can unintentionally loosen and/or slip off the user's head, along with the eyeglass. This is more common when the user engages in aggressive activities and sports such as windsurfing, wakeboarding, sailing, rafting, mountain biking, skiing, snowboarding, or the like.

As such, there is a need in the industry for a leash apparatus for use with an eyeglass retaining band that serves as a secondary safety device that minimizes the chance of loss and/or damage to the eyeglass.

### SUMMARY

A leash apparatus for use with an eyeglass retaining band positioned around a user to maintain an eyeglass at a desired position on a body of the user is provided. The leash apparatus is configured to prevent loss of the eyeglass secured to the retaining band when the user engages in an activity. The leash apparatus comprises a resilient tether comprising a first end and a second end, the tether configured to extend or compress to a desired length, a first ring mechanically coupled to the first end of the tether and configured to be secured around the eyeglass retaining band, and a clip mechanically coupled to the second end of the tether and comprising a pair of jaws, the clip comprising an adjustment mechanism configured to adjust a separation distance between the jaws to be sufficiently large to receive an article on the body of the user, wherein the tether is configured to adjust to the desired length to permit the jaws to secure the article therein.

In alternative embodiments, the leash apparatus may be used to retain other items to the user's body such as hats, cameras, keys, wallets, or the like.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the leash apparatus shown in use;

FIG. 2 depicts a perspective view of certain embodiments of the leash apparatus;

FIG. 3 depicts an exploded view of certain embodiments of the leash apparatus;

FIG. 4 depicts a top view of certain embodiments of the leash apparatus;

FIG. 5 depicts a side view of certain embodiments of the leash apparatus;

FIG. 6 depicts a section view of certain embodiments of the leash apparatus taken along line 6-6 in FIG. 5;

FIG. 7 depicts a section view of certain embodiments of the leash apparatus illustrating the clip in an open configuration;

FIG. 8 depicts a section view of certain embodiments of the leash apparatus; and

FIG. 9 depicts a perspective view of an alternative embodiment of the leash apparatus.

### DETAILED DESCRIPTION OF CERTAIN EMBODIMENTS

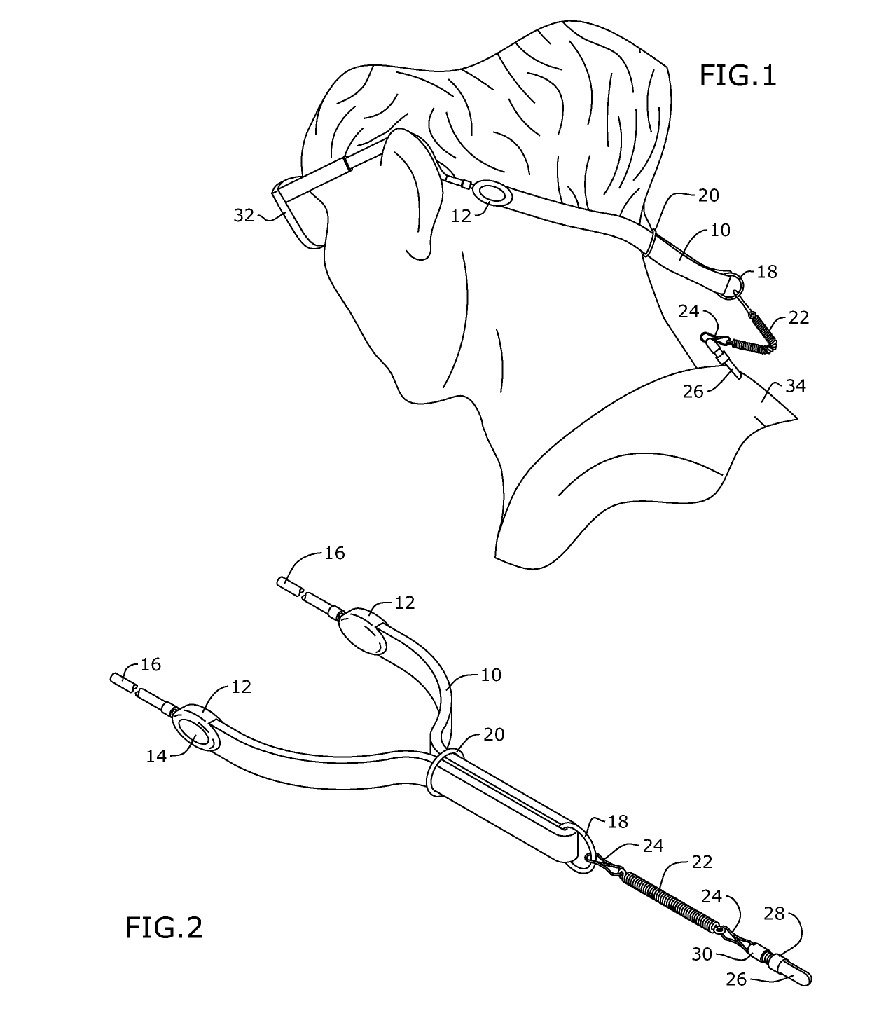

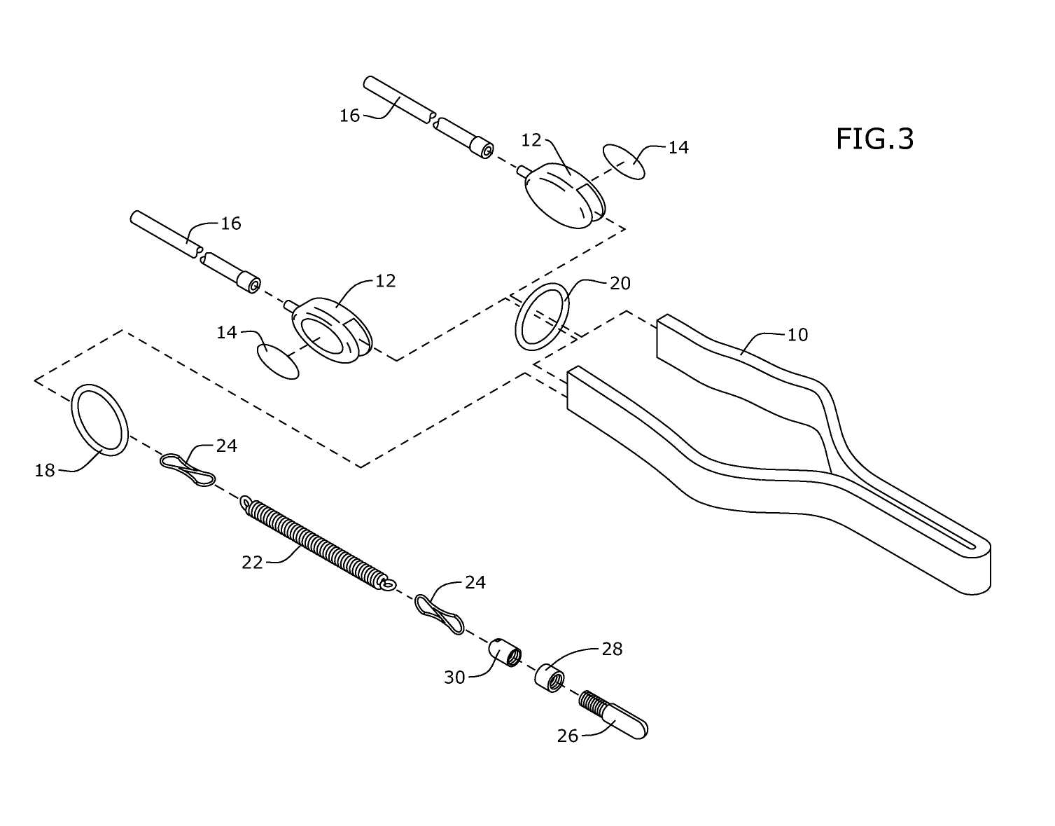

As depicted in FIGS. 1-3, a leash apparatus is configured for use with an eyeglass retaining device to secure glasses 32 to a desired position on the user's head. In certain embodiments, the leash apparatus comprises large O-ring 18, coiled tether 22 and clip 26. The eyeglass retaining device comprises strip 10, end caps 12 and tube strips 16. The leash apparatus is configured to be secured to strip 10 of the eyeglass retaining device and an article on the user's body such as shirt 34.

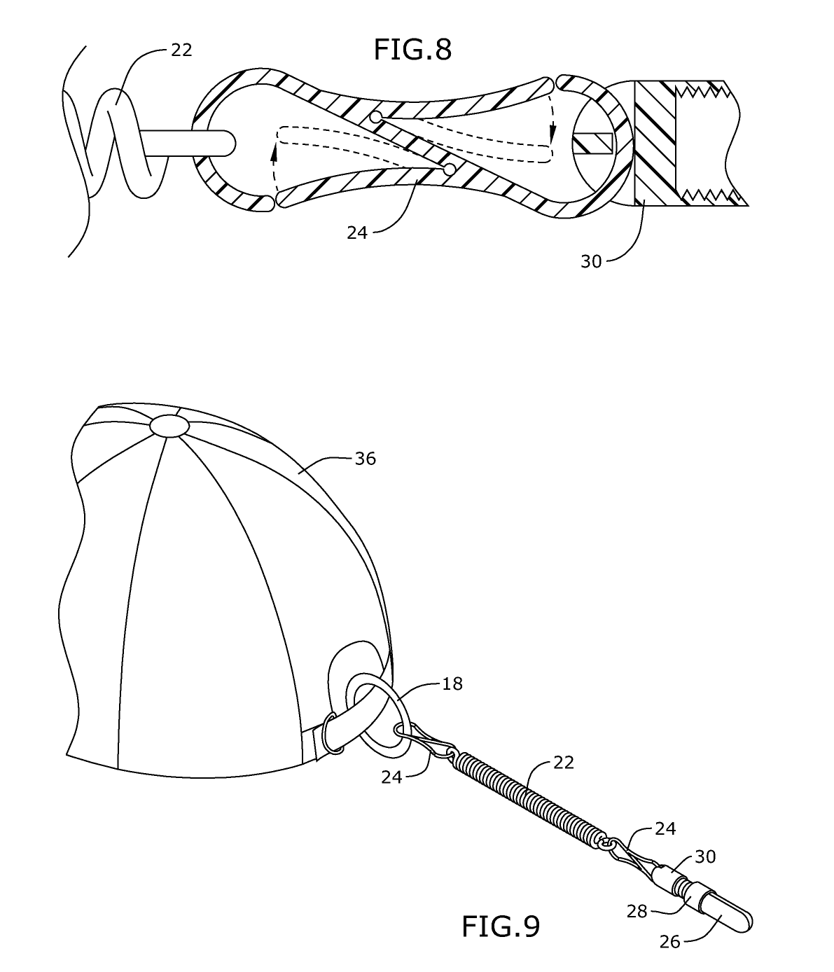

The leash apparatus comprises coiled tether 22, which is preferably a polyurethane resilient member that is configured to stretch or compress to a desired length. Each end of coiled tether 22 comprises a loop that is configured to receive snap hook 24. As depicted in FIG. 8, each snap hook 24 is a fastening component having a pair of oppositely positioned hooks. Each hook comprises a squeezable portion that opens and closes the hook. The loop on the first end of coiled tether 22 is configured to receive a first snap hook 24 that is also coupled to large O-ring 18. The loop on the second end of coiled tether 22 is configured to receive a second snap hook 24 that is also coupled to clip cap 30. Clip cap 30 comprises a threaded internal opening and a slot to receive a hook portion of snap hook 24. Clip 26 comprises a threaded shaft connected to a pair of jaws having internal teeth. The threaded shaft of clip 26 is configured to engage with the threaded internal opening of clip cap 30. Ring nut 28 is a tubular member with internal threads that engage with the threaded shaft of clip 26. Ring nut 28 can be rotatably adjusted relative to the threaded shaft of clip 26 to adjust the separation distance between the jaws of clip 26 to be sufficiently large to receive shirt 34.

In certain embodiments of the invention, the eyeglass retaining device comprises strip 10, which is preferably a flexible neoprene member that is ¼″ thick. End caps 12 are preferably made from plastic and are coupled to both ends of strip 10. Specifically, each end cap 12 comprises a slot to receive an end of strip 10. An adhesive such as glue may be used to secure the components together. Each end cap 12 further comprises an opening to receive end cap insert 14. End cap insert 14 may have any decorative markings, names, logos, or the like, to enhance aesthetics of the eye glass retaining device. Each end cap 12 further comprises a nub, which is inserted into tube strip 16. The pair of tube strips 16 is secured over the temple tips of glasses 32.

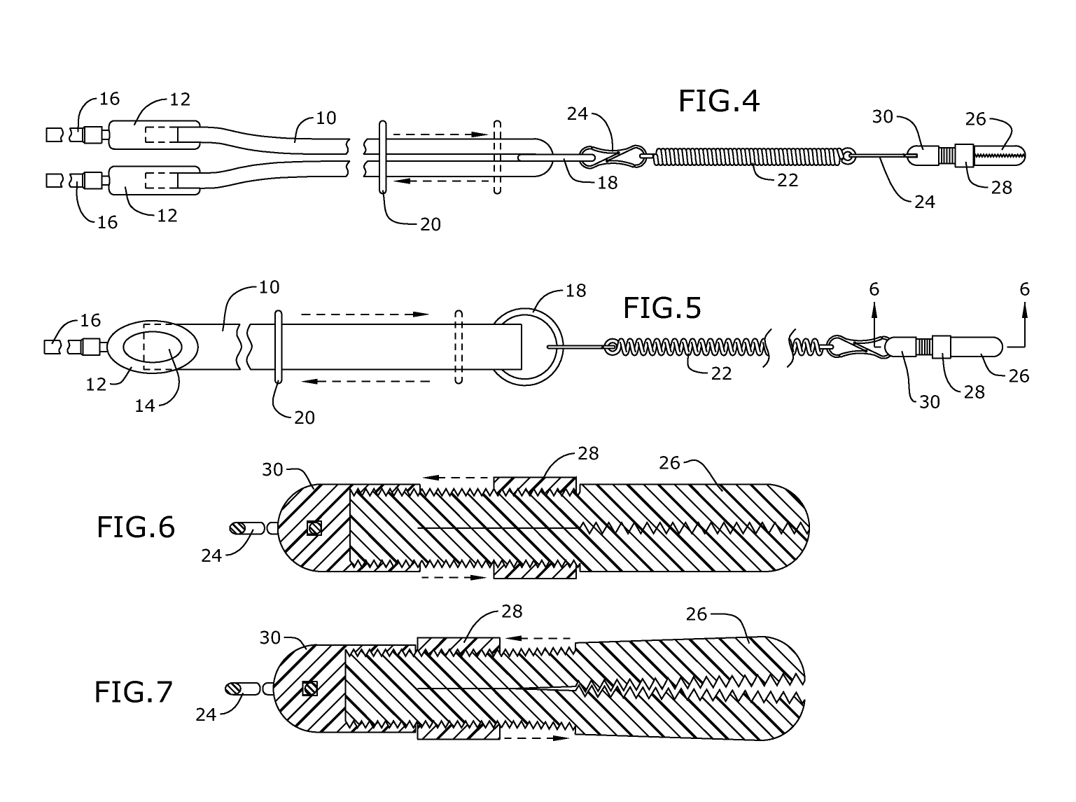

In operation, a user secures large O-ring 18 of the leash apparatus around strip 10 as depicted in FIGS. 4-5. Tube strips 16 of the eyeglass retaining device are disposed around the temple tips of glasses 32 as shown in FIG. 1. Small O-ring 20 is disposed around strip 10 and is configured to slidably adjust relative to strip 10 as shown in FIGS. 4-5. This adjusts strip 10 to conform to the head or neck region of the user to better secure the eyeglass retaining device thereto. Clip 26 of the leash apparatus is secured to shirt 34 worn by the user. Specifically, ring nut 28 is rotatably adjusted relative to the threaded shaft of clip 26 to enable the separation distance between jaws to be sufficiently large to receive shirt 34. FIG. 6 depicts ring nut 28 adjusted such that the jaws of clip 26 are in a closed position. FIG. 7 depicts ring nut 28 adjusted such that the jaws of clip 26 are separated to receive shirt 34. It shall be appreciated that ring nut 28 can be rotatably adjusted gradually to maintain the proper jaw separation distance to secure shirts with different thicknesses.

Although the figures depict clip 26 secured to shirt 34, it shall be appreciated that clip 26 may be secured to any article of clothing or object on the user's body including, but not limited to, shorts, pants, jackets, other shirts, belts, or the like. In this configuration, the leash apparatus will remain attached to shirt 34 and will retain glasses 32 and the eyeglass retaining device in the event they become detached from the user's body.

As depicted in FIG. 9, the leash apparatus may be used to retain alternative items such as hat 36. In this configuration, large O-ring 18 is disposed around a portion of hat 36 such as a strap. Clip 26 is secured to shirt 34 in the same manner as described above. If the user engages in an activity that causes hat 36 to fall off the head, the leash apparatus will retain the hat close to the user's body. It shall be appreciated that large O-ring 18 may be beneficial in securing alternative items including, but not limited to, cameras, keys, wallets, other personal belongings, or the like.

It shall be appreciated that the components of the leash apparatus described in several embodiments herein may comprise any alternative known materials in the field and be of any color, size and/or dimensions. It shall be appreciated that the components of the leash apparatus described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A leash apparatus for use with an eyeglass retaining band positioned around a user to maintain an eyeglass at a desired position on a body of the user, the leash apparatus configured to prevent loss of the eyeglass secured to the retaining band when the user engages in an activity, the leash apparatus comprising:
a resilient tether comprising a first end and a second end, the tether configured to extend or compress to a desired length;
a first ring mechanically coupled to the first end of the tether and configured to be secured around the eyeglass retaining band; and
a clip mechanically coupled to the second end of the tether and comprising a pair of jaws, the clip comprising an adjustment mechanism configured to adjust a separation distance between the jaws to be sufficiently large to receive an article on the body of the user, wherein the tether is configured to adjust to the desired length to permit the jaws to secure the article therein.

2. The leash apparatus of claim 1, wherein the clip comprises a threaded portion that extends from a first end of the clip to an intermediate portion and the pair of jaws extends from the intermediate portion to a second end of the clip.

3. The leash apparatus of claim 2, wherein the adjustment mechanism comprises a tubular member with interior threads coupled to the threaded portion of the clip, wherein the tubular member is configured to rotatably adjust relative to the threaded portion of the clip to adjust the separation distance between the jaws.

4. The leash apparatus of claim 3, further comprising a cap member mechanically coupled to the first end of the clip.

5. The leash apparatus of claim 4, further comprising a first snap hook coupled to both the first ring and the first end of the tether, and a second snap hook coupled to both the second end of the tether and the cap member.

6. The leash apparatus of claim 5, wherein the tether is a coiled leash.

7. The leash apparatus of claim 5, wherein the eyeglass retaining band comprises a flexible strip disposed within the first ring and comprising a pair of strip ends, an end cap coupled to each strip end, and a tube strip coupled to each end cap, wherein each tube strip is configured to be disposed around a temple portion of the eyeglass.

8. The leash apparatus of claim 7, further comprising an insert coupled to an opening in each end cap.

9. The leash apparatus of claim 8, further comprising a second ring disposed around the flexible strip, wherein the second ring is configured to slidably adjust relative to the flexible strip to secure the strip to the body of the user.
